(19) United States
(12) Patent Application Publication
(10) Pub. No.: US 2002/0197092 A1
(43) Pub. Date: Dec. 26, 2002

(54) Multiple pigment application pencil column and pencil slice

(76) Inventor: Irina Iosilevich, Boca Raton, FL (US)

Correspondence Address: FRANK L. KUBLER, 13261 S.W. 54th Court, Miramar, FL, 33027, US

(21) Appl. No.: 10/222,098

(22) Filed: Aug. 16, 2002

Related U.S. Application Data
(63) Continuation-in-part of application No. 09/876,905, filed on Jun. 8, 2001.

(51) Int. Cl. B43K 19/00; B43K 25/00

(52) U.S. Cl. 401/52; 401/49

(57) ABSTRACT

A pigment application pencil includes a pencil column or a pencil plate of pigment material having a composition which readily rubs onto a contacting surface and being divided into several discrete color regions of differing pigment color, the column having at least one longitudinal flat side including portions of at least two of the color regions; so that sliding contact of two color regions on the flat side permits even and uniform parallel application of contrasting pigments along a well defined straight or curving line.

This application is a continuation-in-part of application Ser. No. 09/876,905, Jun. 8, 2001.

### BACKGROUND OF THE INVENTION

1. Field of the Invention

The present invention relates generally to the field of pigment delivery devices, such as for applying cosmetics. More specifically the present invention relates to a pigment application pencil including a unified pencil column or pencil panel of pigment material having a composition which readily rubs onto a contacting surface and is divided radially into discrete color regions of differing pigment color, the column or panel having at least one column side wall segment which may be flat or curved and which exposes portions of at least two of the regions. The pencil panel is alternatively referred to as a pencil slice. The column has an optional outer layer of pencil cover material. Exposure of two or more color regions on a single flat column or plate side wall segment permits even and uniform parallel application of contrasting pigments along a well defined straight or curving line. The pigment material is preferably eyeliner or lipliner, but may be any of many other pigment materials such as a crayon or wax pencil. The pencil cover material is preferably wound paper or plastic which is progressively unwound, by hand at intervals in which the pigment material is worn flush with the cover material.

The circumference of the unified column or panel preferably is formed entirely of such flat sides intersecting at sharp corners, the preferred column or panel cross-sectional shapes including but not limited to triangular, square, pentagonal and hexagonal. These general geometric shapes are still preferably truncated longitudinally at corners to provide alternating long flat sides and short flat sides. Thus, for example, a triangular cross-section becomes a triangle truncated at each corner so that each corner ends in a longitudinal short flat side.

2. Description of the Prior Art

There have long been eyeliner pencils, crayons and other pigment material line application devices which can trace a line of a single color, and of a single given width. A problem with these prior application devices has been that forming adjacent parallel lines cannot be done with ease or precision, since one must use a separate application device loaded with a different pigment and try to trace a line beside and following the first traced pigment color line. Another problem is that there is no provision for drawing lines of various specific widths.

It is thus an object of the present invention to provide a pigment application pencil having a pigment column or panel made up of at least two discrete pigment sections exposed at a single pigment column side or panel side wall segment for precise drawing of a pigment line of immediately adjacent multiple colors.

It is another object of the present invention to provide such a pencil which provides pigment material application pencil columns or pencil panels having one or more flat sides to draw a line of one or multiple colors of a given, uniform width.

It is still another object of the present invention to provide such a pencil which provides a pigment material application column or panel having multiple flat sides of differing uniform widths as well as sharp corners for drawing lines of differing specific widths.

It is finally an object of the present invention to provide such a pencil which is easy to handle and economical to manufacture.

### SUMMARY OF THE INVENTION

The present invention accomplishes the above-stated objectives, as well as others, as may be determined by a fair reading and interpretation of the entire specification.

A pigment application pencil is provided, including a unified column of pigment material having a composition which readily rubs onto a contacting human tissue surface and being divided into several discrete color regions of differing pigment color, the column having a column side wall with at least one longitudinal flat column side wall segment including portions of at least two of the color regions; and an outer layer of pencil cover material; so that sliding contact of two color regions on the flat column side wall segment with a human tissue surface permits even and uniform parallel application of contrasting pigments along a well defined straight or curving line. The discrete color regions are preferably divided radially.

The pigment material preferably is one of: eyeliner and lipliner. The pencil cover material preferably includes wound flexible sheet material for progressively unwinding and removing as the pigment material is worn flush with the cover material. The circumference of the unified column preferably is formed entirely of several of the flat column side wall segments intersecting at corners. The column cross-sectional shape preferably is one of: triangular, square, pentagonal and hexagonal. The cross-sectional geometric shapes preferably are truncated at the corners to define short flat column side wall segments between long flat side wall segments, so that the long and short flat column side segments alternate.

A pigment application pencil is provided, including a column of pigment material having a composition which readily rubs onto a contacting surface and being divided radially into several discrete color regions of differing pigment color, the column having a column side wall with at least one longitudinal flat column side wall segment including portions of at least two of the color regions; and an outer layer of pencil cover material; so that sliding contact of two color regions on the flat column side wall segment permits even and uniform parallel application of contrasting pigments along a well defined straight or curving line.

A pigment application pencil is further provided, including a unified pencil plate of pigment material having a composition which readily rubs onto a contacting surface and being divided into a plurality of discrete color regions of differing pigment color, the pencil plate having a plate first face and a plate second face and a plate side wall formed of at least one plate side wall segment including portions of at least two of the color regions; so that sliding contact of two color regions on the plate side wall with a contacting surface permits even and uniform parallel application of contrasting pigments along a well defined straight or curving line.

The pencil preferably includes several discrete color regions which are radially divided. The pigment material preferably is one of: eyeliner and lipliner. The plate side wall optionally is formed entirely of several plate side wall segments which are flat sides intersecting at corners. The pencil plate optionally has a cross-sectional shape is one of: triangular, square, pentagonal, star and hexagonal. The cross-sectional geometric shapes preferably are truncated at the corners to define short flat sides between long flat sides, so that the long and short flat sides alternate. The plate side wall optionally includes at least one curved plate side wall segment. The plate optionally has a cross-sectional shape which is one of: circular and heart shaped. The contacting surface optionally is a human tissue surface.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a perspective view of a segment of a pigment column having a triangular cross-section with truncated corners and three radially divided color regions.

FIG. 2 is a perspective view of a segment of a pigment column having a square cross-section with truncated corners and four radially divided color regions.

FIG. 3 is a perspective view of a segment of a pigment column having a square cross-section with truncated corners and five radially divided color regions.

FIG. 4 is a perspective view of a segment of a pigment column having a hexagonal cross-section with truncated corners and six radially divided color regions.

FIG. 5 is a perspective view of a segment of a pigment column having a triangular cross-section and three radially divided color regions.

FIG. 6 is a perspective view of a segment of a pigment column having a square cross-section and four radially divided color regions.

FIG. 7 is a perspective view of a segment of a pigment column having a pentagonal cross-section and five radially divided color regions.

FIG. 8 is a perspective view of a segment of a pigment column having a hexagonal cross-section and six radially divided color regions.

FIG. 9 is a pencil having a pigment column with a triangular cross-section having truncated corners and three radially divided color regions, the pencil tracing a line with two adjacent discrete longitudinal color portions deposited by two of the color regions.

FIG. 10 is a front view of a representation of a human eye showing a dual color line on the skin immediately below the eye traced by the inventive pencil having an eyeliner pigment column.

FIG. 11 is a perspective view of a disk-shaped example of the pencil plate of the second embodiment, showing the several color regions which preferable each have a different pigment for multiple color choice.

FIG. 12 is a perspective view as in FIG. 11, showing a square or rectangular plate example of the pencil plate, having a large square color region, two elongate edge color regions and a small square color region.

FIG. 13 is a perspective view as in FIG. 12, but having diagonal color region divisions.

FIG. 14 is a perspective view as in FIG. 11, but having an octagonal shape with intersecting, pie cut color region divisions.

FIG. 17 is a perspective view as in FIG. 11, but with greater proportionate depth so that the pencil plate is cubical.

FIGS. 15, 16 and 18-23 are top plan views of pencil plates having other contemplated perimeter shapes, namely triangular, duck or swan shaped, heart shaped, arrow cross shaped, fan shaped, another octagon, star shaped and another cross shaped variation. It is understood that these are only examples and other perimeter shapes are contemplated.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

First Preferred Embodiment

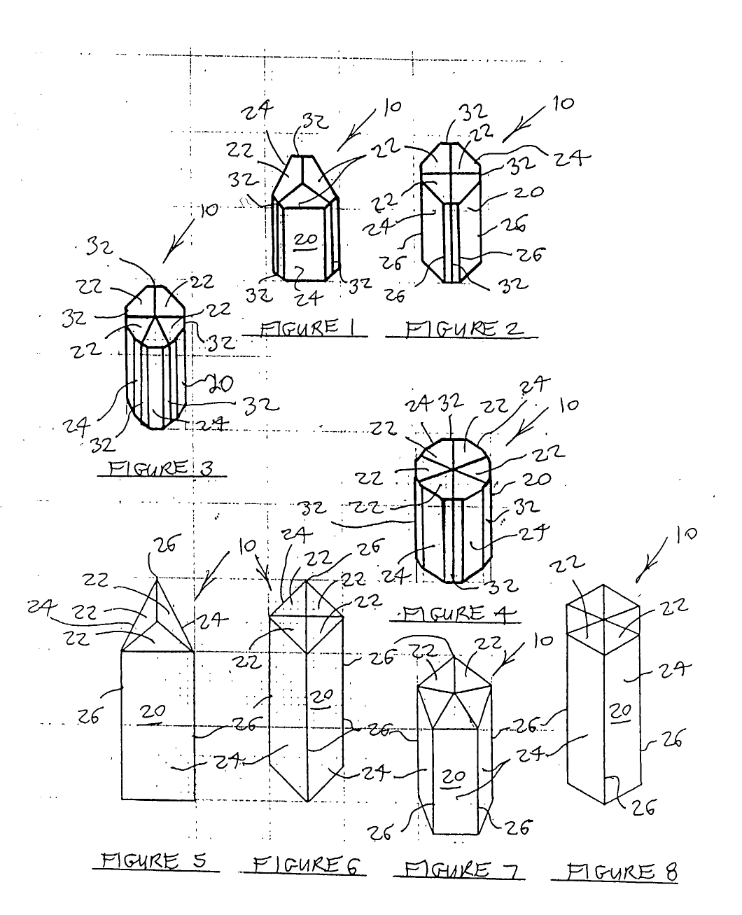

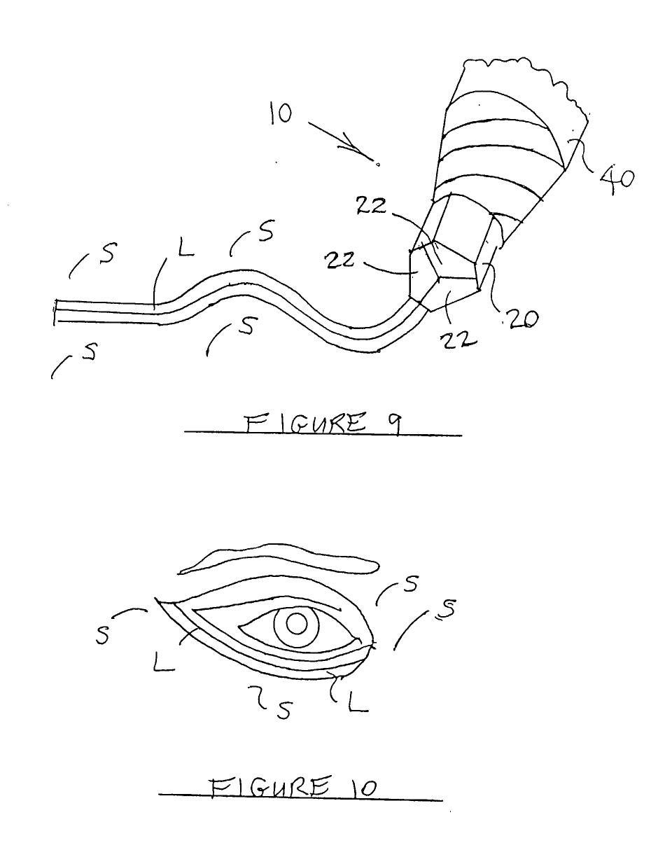

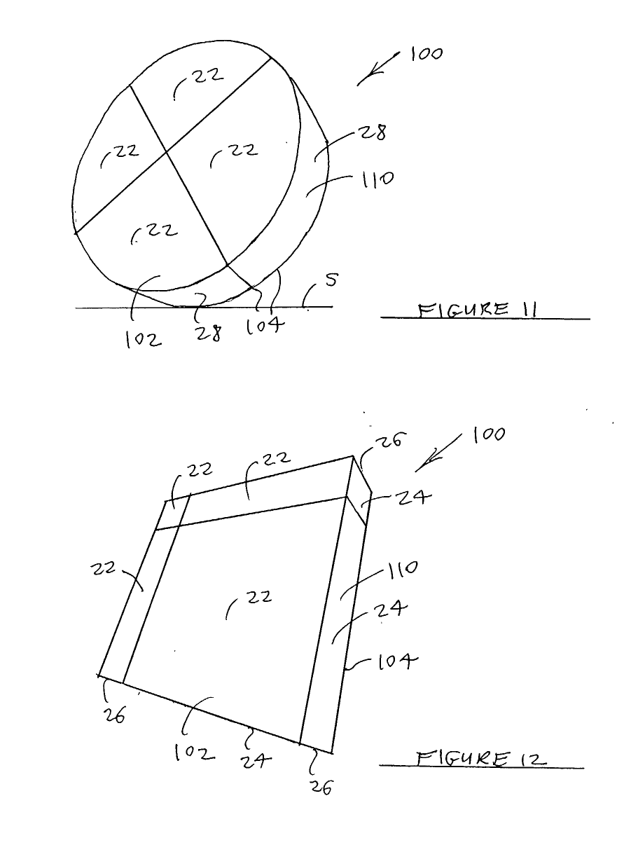

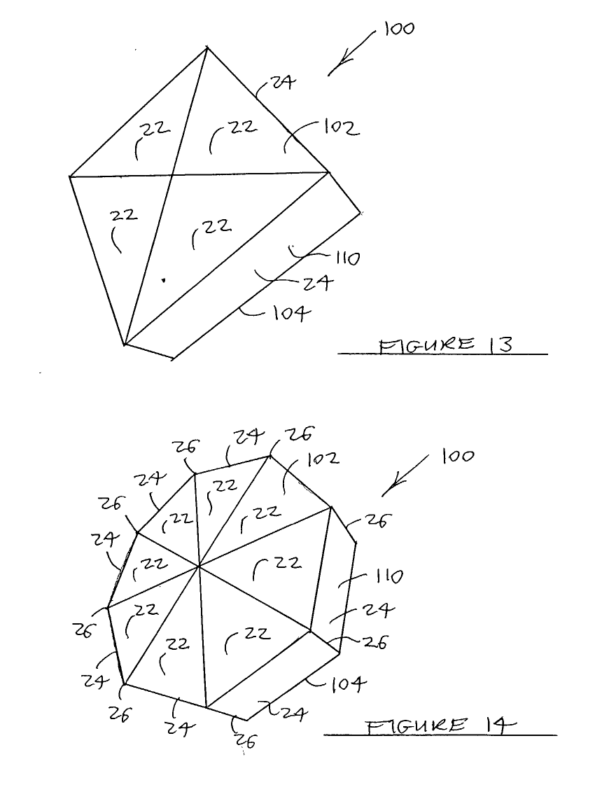

Referring to FIGS. 1-10, a pigment application pencil 10 is disclosed, including a column 20 of pigment material having a composition which readily rubs onto a moving, contacting surface S such as of human tissue and is divided into discrete color regions 22 of differing pigment color, the column 20 having a column side wall formed of at least one longitudinal flat column side wall segment 24 including portions of at least two of the regions 22, and an optional outer layer 40 of pencil cover material. The discrete color regions 22 are preferably, although not necessarily, divided from each other along radial column 20 lines. Exposure of two or more color regions 22 on a single flat column side wall segment 24 permit even and uniform parallel application of contrasting pigments along a well defined straight or curving line L. The column is preferably unified and singular, but alternatively may be a bundle of pigment material sticks of differing colors. The pigment material is preferably eyeliner or lipliner, but may be any of many other pigment materials such as crayon material. The pencil cover material is preferably wound paper or plastic which is progressively unwound by hand at intervals in which the pigment material is worn flush with the cover material. The unwinding cover material at the distal end of the pencil leaves a substantially conical outer layer shape, as is known in conventional wax pencil design.

The circumference of unified column 20 preferably consists entirely of such flat column side wall segments 24 intersecting at sharp corners 26, the preferred column 20 cross-sectional shapes including but not limited to triangular, square, pentagonal and hexagonal. A single narrow line of pigment material can be applied by dragging a corner 26 over a surface to be marked. These general geometric shapes are still preferably truncated at longitudinal corners 26 to provide alternating long flat column side wall segments 24 which can be dragged over a surface to be marked to produce pigment lines of full width and short flat sides 32, which can be dragged over a surface to be marked to produce pigment lines of medium width. Thus a triangular cross-section becomes a triangle truncated at each corner 26 so that each corner 26 ends in a longitudinal short flat side 32. See FIGS. 1 and 9.

Second Preferred Embodiment

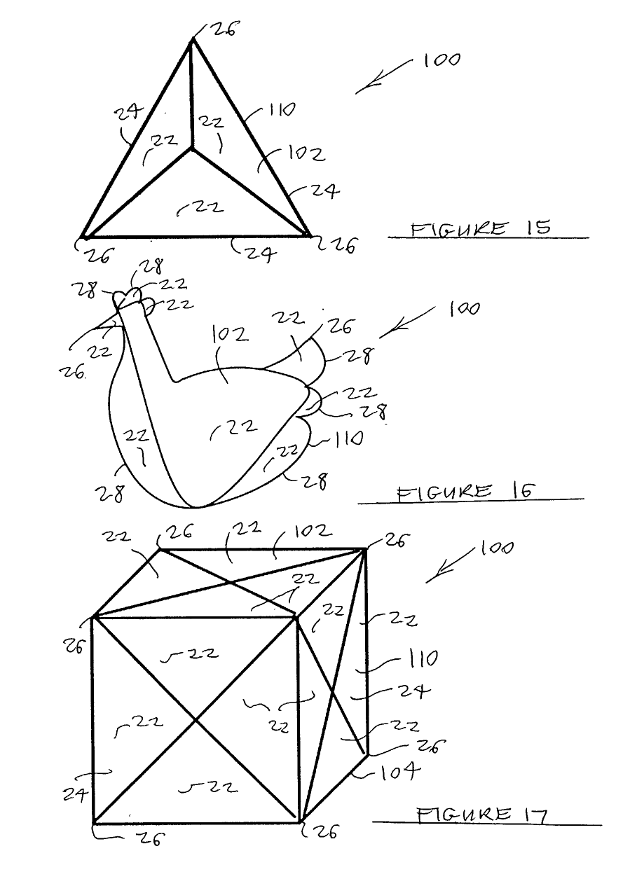

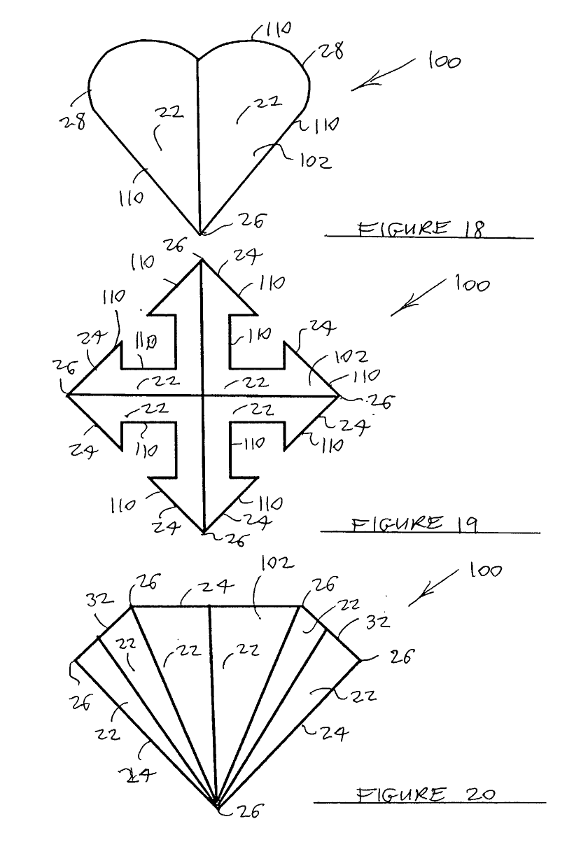

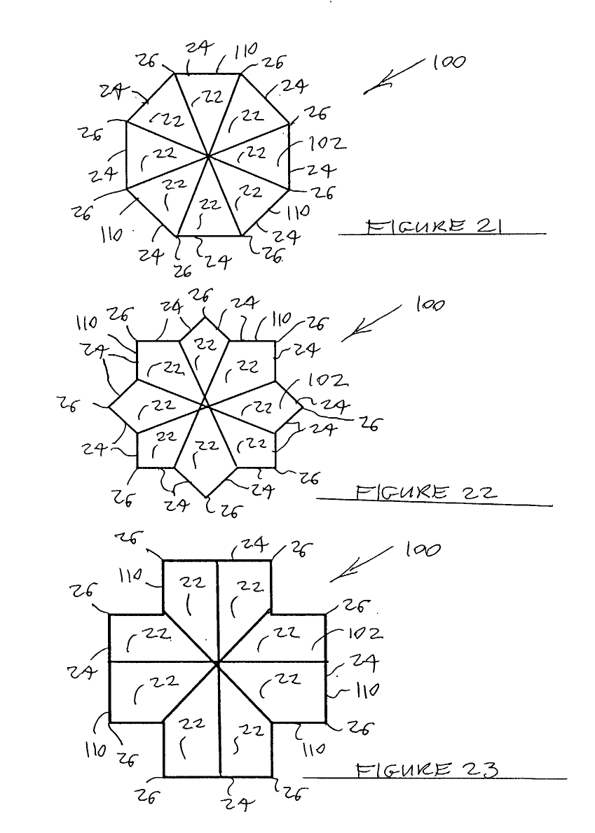

A second embodiment is provided in the form of a pencil plate 100, also referred to as a pencil slice, which essentially is a cross-sectionally cut and diametrically enlarged segment of a pencil column 20 of the first embodiment, omitting outer layer 40 of cover material. See FIGS. 11-23. Each pencil slice 100 preferably is large enough to be gripped between user fingers while protruding outwardly from between the user fingers for rubbing, and is formed of pigment material and has a first slice face 102 and a second slice face 104 and a circumferential or parametric plate side wall 110 following any one of many possible geometric shapes. See FIGS. 15-23, which illustrate examples of such circumferential side wall 110 geometric shapes. As in the first embodiment, the pigment material preferably has a composition which readily rubs onto a contacting surface S such as of human tissue, or paper or other materials and is divided into discrete color regions 22 of differing pigment color, the circumferential side wall 110 has at least one longitudinal flat side wall segment 24 including portions of at least two of the regions 22. A selected flat plate side wall segment 24 or, curved side wall segments 28 of circumferential side wall 110 are rubbed against a contacting surface S to leave a trail of color matching that of the pigment of the corresponding region or regions 22. Alternatively, first slice face 102 or second slice face 104 may be rubbed against a contact surface S for a broad, mixed or multiple pigment trail of color.

And once again, as in the first embodiment, the discrete color regions 22 are preferably, although not necessarily, divided from each other along radial lines. Exposure of two or more color regions 22 on a single flat plate side wall segment 24 permit even and uniform parallel application of contrasting pigments along a well defined straight or curving line L. The pencil plate 100 is preferably unified and singular, but alternatively may be a bundle of pigment material fragments of differing colors. The pigment material is preferably eyeliner or lipliner for cosmetic use, but may be any of many other pigment materials such as crayon material for cosmetic or for school or play use by children. The pencil plate 100 is well suited to child use because the corners, even sharp corners, are safe because the pigment material selected normally is soft.

The circumference of unified pencil plate 100 optionally consists entirely of such flat plate side wall segments 24 intersecting at sharp corners 26, the preferred pencil plate 100 cross-sectional shapes including but not limited to triangular, square, pentagonal, star and hexagonal or includes curved plate side wall segments 28, including but not limited to circular, heart and flower shapes. A single narrow line of pigment material can be applied by dragging a corner 26 or curved plate side wall segment 28 over a surface to be marked. Flat plate side wall segment 24 geometric shapes once again are preferably truncated at longitudinal corners 26 to provide alternating long flat plate side wall segments 24 which can be dragged over a surface to be marked to produce pigment lines of full width and short flat sides 32, which can be dragged over a surface to be marked to produce pigment lines of thin, wide or medium width. Thus a triangular cross-section becomes a triangle truncated at each corner 26 so that each corner 26 ends in a longitudinal short flat side 32.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A pigment application pencil, comprising:
a unified column of pigment material having a composition which readily rubs onto a contacting surface and being divided into a plurality of discrete color regions of differing pigment color, said column having a column side wall with at least one longitudinal flat column side wall segment including portions of at least two of the color regions;
and an outer layer of pencil cover material;
such that sliding contact of two color regions on said flat side with a contacting surface permits even and uniform parallel application of contrasting pigments along a well defined straight or curving line.

2. The pencil of claim 1, wherein said plurality of discrete color regions are radially divided.

3. The pencil of claim 1, wherein said pigment material is one of: eyeliner and lipliner.

4. The pencil of claim 1, wherein said pencil cover material comprises wound flexible sheet material for progressively unwinding and removing as said pigment material is worn flush with said cover material.

5. The pencil of claim 1, wherein the column side wall is formed entirely of a plurality of said flat column side wall segments intersecting at corners.

6. The pencil of claim 5, wherein said column cross-sectional shape is one of: triangular, square, pentagonal and hexagonal.

7. The pencil of claim 5, wherein said cross-sectional geometric shapes are truncated at said corners to define short flat column side wall segments between long flat column side wall segments, such that said long and short flat plate side wall segments alternate.

8. A pigment application pencil, comprising:
a column of pigment material having a composition which readily rubs onto a contacting surface and being divided into a plurality of discrete color regions of differing pigment color, said column having a column side wall with at least one longitudinal flat column side wall segment including portions of at least two of the color regions;
and an outer layer of pencil cover material;
such that sliding contact of two color regions on said flat side permits even and uniform parallel application of contrasting pigments along a well defined straight or curving line.

9. The pencil of claim 8, wherein said plurality of discrete color regions are radially divided.

10. A pigment application pencil, comprising:
a unified pencil plate of pigment material having a composition which readily rubs onto a contacting surface and being divided into a plurality of discrete color regions of differing pigment color, said pencil plate having a plate first face and a plate second face and a plate side wall formed of at least one plate side wall segment including portions of at least two of the color regions;
such that sliding contact of two color regions on said plate side wall with a contacting surface permits even and uniform parallel application of contrasting pigments along a well defined straight or curving line.

11. The pencil of claim 10, wherein said plurality of discrete color regions are radially divided.

12. The pencil of claim 10, wherein said pigment material is one of: eyeliner and lipliner.

13. The pencil of claim 10, wherein said plate side wall is formed entirely of a plurality of said plate side wall segments are flat sides intersecting at corners.

14. The pencil of claim 13, wherein said plate has a cross-sectional shape is one of: triangular, square, pentagonal, star and hexagonal.

15. The pencil of claim 13, wherein said cross-sectional geometric shapes are truncated at said corners to define short flat sides between long flat sides, such that said long and short flat sides alternate.

16. The pencil of claim 10, wherein said plate side wall comprises at least one curved plate side wall segment.

17. The pencil of claim 13, wherein said plate has a cross-sectional shape is one of: circular and heart shaped.

18. The pencil of claim 10, wherein said contacting surface is a human tissue surface.

19. The pencil of claim 1, wherein said contacting surface is a human tissue surface.
